(19) United States
(12) Patent Application Publication
(10) Pub. No.: US 2017/0240991 A1
(43) Pub. Date: Aug. 24, 2017

(54) Flat Steel Product and Method for Producing a Flat Steel Product

(71) Applicant: ThyssenKrupp Steel Europe AG, Duisburg (DE)

(72) Inventors: Janko Banik, Altena (DE); Marc Blumenau, Hagen (DE); Maria Koeyer, Dortmund (DE); Tobias Lewe, Munster (DE); Axel Schrooten, Dortmund (DE)

(21) Appl. No.: 15/591,519

(22) Filed: May 10, 2017

Related U.S. Application Data
(63) Continuation of application No. 14/003,324, filed on Nov. 4, 2013.

(30) Foreign Application Priority Data
Mar. 8, 2011 (DE) 102011001140.4

(51) Int. Cl. C21D 9/46; C21D 1/673; B32B 15/01; C23F 17/00; B32B 15/18; C23C 2/06; C23C 2/28; C21D 8/02; B32B 15/04

(52) U.S. Cl. CPC C21D 9/46; C21D 8/0278; C21D 1/673; B32B 15/013; B32B 15/043; B32B 15/18; C23C 2/06; C23C 2/28; C23F 17/00

(57) ABSTRACT

The invention relates to a flat steel product, which is intended to be formed into a component by hot press forming and has a base made of steel, onto which a metal anti-corrosion coating is applied, which is formed by Zn or a Zn alloy. This is achieved as per the invention in that a separate finishing coat is applied to at least one of the free surfaces of the flat steel product which contains at least one base metal compound (oxide, nitride, sulphide, sulphate, carbide, carbonate, fluoride, hydrate, hydroxide, or phosphate). Furthermore the invention relates to a method enabling the production of a flat steel product of this kind.

### CROSS-REFERENCE TO RELATED APPLICATIONS

This application is a continuation of U.S. application Ser. No. 14/003,324 filed Nov. 4, 2013 which is the United States national phase of International Application No. PCT/EP2012/054013 filed Mar. 8, 2012, and claims priority to German Patent Application No. 10 2011 001 140.4 filed on Mar. 8, 2011, the disclosures of which are hereby incorporated by reference in their entirety.

### BACKGROUND OF THE INVENTION

Field of the Invention

The invention relates to a flat steel product which is intended for heat treatment. Heat treatment involves, for example, heating to a deformation temperature at which the flat steel product is thermoformed into a component. Hot working can be carried out as hot press forming where the flat steel product heats up to a sufficiently high temperature to form a martensitic structure, is then deformed and cooled rapidly to form the strength-enhancing martensitic structure.

Furthermore, the invention relates to a method for producing a flat steel product of this type.

‘Flat steel products’ in this context mean steel strips, sheet steel or blanks derived therefrom.

Description of Related Art

The mechanical properties of flat steel products can be influenced by the most varied heat treatments. Depending on their strength, deformation behaviour and their thickness, flat steel products can also only be formed into components when hot. Heat treatment or heat deformation generally requires heating the flat steel product to be treated or deformed from a low initial temperature to a significantly higher temperature required for heat treatment or heat deformation. From the perspective of optimum energy use, minimum processing time and optimum process control options, there is a requirement for an effective as possible transfer of the heat energy generally introduced as heat radiation to the flat steel product.

An example of a method dependent on a high level of effectiveness of the heat input into the flat steel product to be heated is hot press forming.

In order to meet the current demand in modern vehicle body construction for a combination of light weight, maximum strength and protective effect, hot press-formed components made of high tensile steel are used today in those areas of the vehicle body, which can be subjected to particularly heavy stresses in the event of a crash.

In hot press hardening, steel blanks, which are separated from a cold-rolled or hot-rolled steel strip, are heated to a deformation temperature, which is usually above the austenitisation temperature of the respective steel, and placed in the heated state into the die of a forming press. In the course of the forming subsequently carried out, the sheet blank or the component formed from it undergoes rapid cooling through contact with the cool die. The cooling rates are set in such a way that a martensitic structure develops in the component.

A typical example of steel suitable for hot press hardening is known under the designation ‘22MnB5’ and can be found in the Key to Steel 2004 under the material number 1.5528.

The advantages of known MnB steels, particularly suited to hot press hardening are, however, in practice confronted with the disadvantage that steels with a high manganese content are too unstable against wet corrosion and can only be passivated with difficulty.

In order to improve the corrosion resistance of steels containing manganese of the type under discussion, EP 1 143 029 B1 suggests providing a steel blank designated for hot press forming firstly with a zinc coating and then heating it prior to heat deformation such that an intermetallic compound is produced upon heating the flat steel product through a transformation of the coating on the steel sheet. Said compound is intended to protect the steel sheet against corrosion and decarburisation and to assume a lubricating function during hot working in the pressing die.

In addition to anti-corrosion coatings made of zinc (‘Z coating’) or a zinc alloy (for example, zinc aluminium (‘ZA coatings’) with up to 5% wt. Al, zinc ferrite (‘ZF coatings’) with up to 15% wt. Fe, more particularly Fe content of at least 8% wt., zinc nickel (‘ZN coatings’) with up to 12% wt. Ni, more particularly Ni content of least 8% wt., or zinc magnesium coatings (‘ZM coatings’) with up to 5% wt. Mg, more particularly Mg content of at least 0.5% wt. as well as up to 3% wt. Al, more particularly Al content of at least 0.2% wt., corrosion-sensitive flat steel products intended for hot press hardening are also provided in practice with an AlSi layer (‘AS coatings’) with up to 12% wt. Si, more particularly Si content of at least 8% wt., or an AlZn layer (‘AZ coatings’) with up to 49% wt. Zn and optionally up to 2% wt. Si, more particularly [Zn] content up to 43.4% wt. and up to 1.6% wt. Si. Zinc aluminium layers (‘ZA coatings’) with up to 5% wt. Al are also used as metallic anti-corrosion coatings. AS coatings of the above-mentioned type typically have Si content of up to 10% wt. here. The above-mentioned coatings can be applied to the respective steel substrate in a particularly economical manner by hot dip coating (DE 10 2006 053 819 A1).

For hot press form hardening, flat steel products coated in this manner must be brought to a desired temperature at a certain speed at which temperature they are subsequently hot press formed. In practice, this results in the problem that the radiant heat is reflected onto the smooth and reflective surfaces of the metallic anti-corrosion coating applied to the flat steel product. This leads to a significant delay in the heating process with the result that more time and energy is required for heating. Moreover, particularly in protective coatings with a higher Al content, deposits build up on the furnace rollers as a result of the reaction between the coating and the ceramic furnace rollers. The diffusion of metallic Al creates the risk that furnace rollers will break due to thermal dilation of the penetrated metal. Finally, abrasion, deposits and build-up of the protective coating material can occur on the surface of the forming die used. This risk is also present particularly if the anti-corrosion coating on the flat steel product has a high Al content.

A method for producing a hardened steel component with areas of different ductility is known from DE 10 2008 027 460 A1. In said method, the behaviour of the steel sheet is changed during heating such that the heat absorption capacity of the steel sheet is influenced during heating to harden depending on the desired degree of hardness. Good heat absorption behaviour is realised for this purpose for high degrees of hardness and reduced heat absorption behaviour for less hard areas. It should be possible in this manner to vary the configuration of the structure over the surface of the component or over the surface of the blank respectively, wherein adjustment of the structure and the heat absorption behaviour can be controlled by the surface emissivity. Thus the aim of the known method is to set locally different degrees of hardness during quench hardening from the austenite phase and stipulates ‘surface emissivity’ for this purpose, i.e. to modify the capacity of the surface or the degree of absorption in locally restricted areas. This change is intended to be achieved in metallic coatings with zinc or on the basis of zinc by adjusting the thickness of the coating in accordance with the respective surface emissivity required. Consequently, a thinner coating is applied in the areas intended to be subjected to greater heat in order, as a result of an increased alloyed coating with the steel substrate of the flat steel product, to obtain a darker colour that absorbs the heat radiation better thereby creating higher surface emissivity of the coating. Greater zinc coating thicknesses on the other hand should lead to fewer discolourations and at the same time to lower surface emissivity and correspondingly less intense heating.

### SUMMARY OF THE INVENTION

Against the background of the prior art explained above, the object of the invention is to create a flat steel product that can be brought to the initial temperature required for the respective heat treatment within shorter heating times. Moreover, a method, which allows the production of such a flat steel product, shall also be indicated.

According to the invention, a flat steel product intended for heat treatment is additionally coated on at least one of its free surfaces with a separate finishing coat which contains an oxide-, nitride-, sulphide-, sulphate-, carbide-, carbonate-, fluoride-, hydrate-, hydroxide- or phosphate-compound of a base metal.

Practical tests have shown that the advantages of the invention explained in detail below already appear in flat steel products where the finishing coat is applied directly onto the surface of the steel substrate and where therefore no further coatings are present on the flat steel product.

The application of a finishing coat as per the invention has proven particularly advantageous in flat steel products, however, which comprise a base consisting of steel and a metallic anti-corrosion coating applied to the base. In this case, the finishing coat as per the invention is applied to the protective coating and consequently the finishing coat seals the layer structure formed on the base on the outer side thereof.

Also in the case of flat steel products in which the base is coated with a non-metallic coating, the application of a finishing coat as per the invention significantly improves the heating behaviour. Such non-metallic coatings applied to the base include, for example, temperature-stable, abreacted organic compounds, such as carbon black, sodium or calcium-based salts, nitrates and phosphates, such as NaCl, Na₂O, KNO₃, K₃PO₄, K₂SO₄, K₂S, K₂CO₃, CaCO₃, each of which have a high melting or boiling point.

According to the invention, a finishing coat is applied accordingly in a separate step and irrespective of the other coatings optionally present on the flat steel product as per the invention. Firstly, this finishing coat reduces the reflection capacity of the flat steel product, more particularly of the coating optionally present on the flat steel product. The surface of a flat steel product coated in a manner as per the invention is generally duller and is characterised by an increased ability to absorb infrared radiation.

Consequently, absorption levels (the terms ‘absorption level’ and ‘absorption coefficient’ are used synonymously here) between 0.3 and 0.99% are achieved using a finishing coat as per the invention.

Accordingly, flat steel products coated with a finishing coat as per the invention absorb between 30% and 99% of the heat radiation striking them.

It has been demonstrated in the process that the metallic compound derived from the oxide, nitride, sulphide, sulphate, carbide, carbonate, fluoride, hydrate, hydroxide or phosphate group present in the finishing coat as per the invention, is temperature-stable in the typical temperature range for the heat treatment of steel of between 300 and 1200° C. and consequently also enables extremely effective heating even at high temperatures corresponding to at least the Ar3 temperature, as generally required for hot press forming, for example.

Secondly, the finishing coat provided as per the invention on a flat steel product of the type described above acts like a lubricant and thus improves the suitability of flat steel products for forming into components by hot press forming.

At the same time, the finishing coat acts like a barrier and prevents direct contact between the flat steel product and the rollers or other parts of the furnace used to heat the flat steel product. This proves particularly advantageous if the flat steel product as per the invention is covered with an anti-corrosion coating, which may melt as a result of heating. In flat steel products coated in this manner, the finishing coat applied as per the invention can prevent deposits from building up in the heating furnace in forming dies used in optional hot forming. Consequently, in a flat steel product as per the invention, not only is the time required to heat to the respective initial hot forming temperature significantly reduced, but also the risk of damage to parts of the heating furnace or the forming die used for optional hot forming is also significantly reduced.

### DESCRIPTION OF THE INVENTION

The requirement as per the invention that one metallic compound derived from the oxide, nitride, sulphide, sulphate, carbide, carbonate, fluoride, hydrate, hydroxide or phosphate group should be present in the finishing coat applied as per the invention naturally implies that the finishing coat also contains a plurality of such compounds. However, it was clear from the practical testing of the invention that the presence of just one of the cited compounds in the finishing coat achieves the desired effects as per the invention.

The positive effects of the finishing coat as per the invention occur independently from the alloying of its base material in all flat steel products.

This applies, as mentioned, particularly if the flat steel product is coated with a metallic anti-corrosion coating onto the outer side of which the finishing coat is applied in turn. Practical tests have shown here that heating times can be significantly reduced, both in the case of flat steel products provided with a zinc-based anti-corrosion coating and in the case of such flat steel products where the anti-corrosion coating is aluminium-based.

Table 1 shows the proportion in ‘%’ for various anti-corrosion coatings by which the heating times are reduced in a flat steel product coated as per the invention compared with a flat steel product without a finishing coat which is heated to the respective initial temperature required for hot press forming. The thickness of the dried finishing coat is in the optimum range between 0.1 and 0.3 pm.

However, in the case of flat steel products coated in this manner, not only a reduction of the required heating times is achieved by the invention, but also a significant reduction in the build-up of deposits and improved deformation behaviour in the forming die.

The substances present in a finishing coat provided as per the invention are temperature resistant and at temperatures of up to 1200° C. have only very slight or even non-existent reactivity, but are characterised by high absorption capacity in the thermal radiation wavelength range of interest here. Specifically considered are inorganic salts formed from base metals (in the form of oxides, sulphides, sulphates, fluorides and phosphates) or salt-like substances such as ionic carbides, carbonates or nitrides. The typical particle size of said substances contributes to the desired increase in surface roughness of the coating which increases the absorption capacity.

The base metals from which the oxide, nitride, sulphate, sulphide, carbide, carbonate, fluoride, hydrate, hydroxide or phosphate compounds of the finishing coat applied to a flat steel product covered optionally with an anti-corrosion coating as per the invention are formed, are according to the understanding of the invention all metals which react under normal conditions with the oxygen in the atmosphere. Moreover, the base metals here also include alkaline earth metals, alkaline metals and semi-metals, also called metalloids, as well as transition metals. Examples of metals from which the compounds present in the finishing coat as per the invention are formed are Na, K, Mg, Ca, B, Al, Si, Sn, Ti, Cr, Mn, Zn.

The base of a flat steel product provided as per the invention consists, for example, of steels alloyed with Mn, as have already been provided in various embodiments in the prior art for hot press forming and explained, as mentioned at the start using the example of the known steel, 22MnB5. Such steels typically have Mn content of between 0.1 and 3% wt. and content of B in order to achieve the required level of strength. Flat steel products, which are produced from such steels, are generally extremely corrosion-sensitive and are therefore coated with a Zn or Al-based protective metal coating which is designed to protect it against corrosion. Even in the hot press forming of such flat steel products where an anti-corrosion coating is applied to the steel base of the flat steel product on which the finishing coat lies, the finishing coat as per the invention proves especially effective.

It was also possible to demonstrate that during hot press forming of flat steel products, which are provided with a Zn or Al-based protective metal coating and in a manner as per the invention with a finishing coat on the top thereof, approx. 80% fewer cracks appeared than in the case of comparative products, which although they had the same protective coating, had been hot press formed without a finishing coat as per the invention.

The compounds in a finishing coat provided as per the invention include, for example, alkaline earth metal compounds such as Mg₃Si₄O₁₀(OH)₂, MgO or CaCO₃, alkaline metal compounds, K₂CO₃ or Na₂Ca₃, NaOH, Na₂CO₃ semi-metal compounds, such as BN, Al₂O₃ (cubic), SiO₂, SnS, SnS₂ and transition metal compounds, such as TiO₂, Cr₂O₃, Fe₂O₃, Mn₂O₃, ZnS.

A finishing coat as per the invention leads to a significant improvement in heat absorption capacity and to a significant reduction of friction during the forming of a flat steel product as per the invention in the respective forming die. This is the case in particular if the metal compounds provided in the finishing coat as per the invention are applied in particle form, wherein this implies the possibility that together the particles form a thick, compact finishing coat. If the average diameter of the particles of the at least one compound present in the finishing coat as per the invention is larger than the average thickness of the finishing coat, a roughness that is particularly advantageous for the effects desired here is obtained. Good results are achieved in the forming of a flat steel product as per the invention if the average diameter of the particles of the compound present in the finishing coat as per the invention is between 0.01 and 5 μm, more particularly between 0.01 and 3 μm. Optimum results are achieved if the average diameter of the particles of the compound is between 0.01 and 0.3 μm.

Alternatively, the finishing coat as per the invention can also be applied as a solution, from which metallic salts develop whilst said coat is drying, which form a crystalline coating on the flat steel product.

The specific advantage of the composition of the finishing coat indicated as per the invention consists in this respect in that its effect is assured even at the high temperatures at which the heat treatment or hot forming of a flat steel product coated as per the invention takes place. The finishing coat adheres so firmly to the respective steel substrate without requiring additional measures resulting in minimal abrasion and slight deposit build-up both in the furnace used to heat the blanks and in the forming die used for optional hot forming.

The latter also proves advantageous in particular if a flat steel product coated as per the invention is heated to the deformation temperature in a continuous furnace and is conveyed in the process on rotating furnace rollers. The finishing coat composed as per the invention of a flat steel product as per the invention remains attached to the furnace rollers at most in small quantities and consequently the wear and tear of the rollers and the cost of their maintenance are kept to a minimum.

Practical tests have shown in this context that the finishing coat composed as per the invention also maintains all its required properties over a sufficiently long period, even after direct temperature exposure in a temperature range typical for hot press forming between 300 and 1200° C., more particularly between 700 and 1000° C., and preferably between 800 and 950° C., and in particular also remains stable at high temperatures until the forming of the respective flat steel product coated as per the invention is finished.

The finishing coat as per the invention also has no adverse influence on the desired oxide layer formation of a protective metal coating optionally present on the flat steel product during the heating phase for hot working. The presence of the finishing coat as per the invention also presents no disadvantages for further processing. In particular, the finishing coat as per the invention does not hamper suitability for welding, bonding, painting or the application of other coatings. Accordingly, there is no need to remove the finishing coat as per the invention between hot press forming and the steps taken subsequently in respect of the component obtained.

The finishing coat applied as per the invention bridges the considerable basic roughness which develops on the respective surface of the flat steel product during heating for subsequent hot press working. Practical tests have shown in this respect that the finishing coat applied as per the invention should be as thin as possible, more particularly between 0.01 and 5 μm thick. Tests revealed that a relatively thin coating of between just 0.1 and 1 μm, more particularly less than 0.5 μm, ideally between 0.1 and 0.3 μm, is sufficient to bring about a complete heat transfer from the finishing coat to the base material of the flat steel product. It was demonstrated in the process that the increase in the heating rate that was achievable and the associated reduction in heating time for a given finishing coat material is largely independent of the respective coating thickness. A particularly thin finishing coat has the advantage here, however, that the chemical/mechanical influence of the finishing coat on the base material and the optional anti-corrosion coating between the finishing coat and the base material is minimal.

In particular, the surface weight at which the finishing coat as per the invention is applied to the flat steel product should be between 0.01 and 15 g/m² on the finished product, more particularly up to 5 g/m², wherein the increase in heat absorption occurs at surface weights of less than 1 g/m². Optimum effects of the finishing coat as per the invention are to be expected here if the surface weight is between 0.02 and 1 g/m². Firstly, with minimal surface coverage of this kind, the friction-reducing effect of the finishing coat is also useful in the forming die. Secondly, with a thin finishing coat as per the invention, negative influences on the results of the steps taken during further processing of a flat steel product as per the invention can be safely ruled out.

Consequently, the invention provides a flat steel product that can not just be heated to a target temperature rapidly and in an energy-saving manner, but is also characterised by optimum deformability.

Carbon black or graphite contents of up to 15% wt. in the finishing coat can further increase the heat absorption capacity of a flat steel product coated as per the invention without adversely affecting the other positive characteristics of the finishing coat and the optional anti-corrosion coating.

From a production perspective, the key advantage of a finishing coat as per the invention consists in that it can be easily applied to the flat steel product, more particularly to the protective metal coating on the steel base present on the flat steel product, in a continuous production process.

The method as per the invention for producing a flat steel product procured in accordance with any of the preceding claims thus includes the following steps:

a) provision of a flat steel product,
b) application of a finishing coat to the flat steel product by
b.1) applying a coating liquid to the flat steel product, wherein between 5 and 50% (as % wt.) of the coating liquid consists of an oxide-, nitride-, sulphate-, sulphide-, carbide-, carbonate-, fluoride-, hydrate-, hydroxide- or phosphate-compound of a base metal and between 1 and 20% of a binder and the rest water, wherein the coating fluid can also contain up to 15% carbon black or graphite,
b.2) setting the thickness of the finishing coat to a thickness of between 0.01 and 5 μm and
c) drying of the finishing coat at a drying temperature, for example between 100 and 300° C.

There is a version of the invention that is particularly important in practice that leads to a significant reduction in processing times and enables optimum exploitation of the available resources where the application of the finishing coat takes place immediately prior to the heating process, in which the flat steel product is heated to the respective temperature required for heat treatment.

The steps provided for the coating of a flat steel product as per the invention can be taken, for example, in a hot dip coating line, electrolytic coating line or coil coating line after the process steps required for application of a protective metal coating in a coating device, which is in a line with the work stations required for application of the protective metal coating and in which the flat steel product exiting the last of said work stations enters a continuous, uninterrupted course of movement. Naturally the finishing coat can also be applied in a separate, continuous line, which is an integral part of a production line, through which the respective flat steel product passes continuously.

Depending on the quantity of other components of the coating liquid applied to the flat steel product, more particularly the optional protective coating on the flat steel product, a finishing coat is provided with an approach as per the invention, which consists of between 20 and 98% wt. of the respective base metal compounds (oxide, nitride, sulphate, sulphide, carbide, carbonate, fluoride, hydrate, hydroxide or phosphate) and the rest consists of the respective other components.

Whilst the respective base metal compounds contained in a coating liquid applied as per the invention make an essential contribution to minimising the friction in the die during hot press forming, the binders also present in the coating liquid ensure a sufficiently firm bonding of the finishing coat formed by the coating liquid to the protective metal coating on the flat steel product. Contents of between 2 and 10% wt. of a suitable binder in the coating liquid have proven adequate.

The respective binder can be an organic or an inorganic binder, such as sodium silicate or cellulose, for example. The respective binder fixes the coating applied as per the invention to the protective coating and prevents the coating applied as per the invention from flaking prior to sheet forming.

If a natural or artificially produced organic binder is used, said binder should be water-soluble and easily dispersible so that water can be easily used as a solvent for the coating liquid. Examples of organic binders are: cellulose ester, cellulose nitrate, cellulose acetate butyrate, styrene acrylic acetate, polyvinyl acetate, polyacrylate, silicon resin and polyester resin. The organic binder should also be selected such that it burns residue-free as far as possible during application or drying of the coating liquid or during heating for the purpose of hot stamping. This has the advantage that weldability is not adversely affected by the binder. The organic binder should also not contain any halogens such as fluoride, chloride or bromide, which, during the combustion process (hot stamping), lead to the release of compounds that are harmful to health, explosive or corrosive.

Particularly good coating results are also achieved if an inorganic binder is used. Such inorganic binders remain on the flat steel product after heating and the press hardening step, and consequently they are also generally identifiable in the finishing coat of the finished product. Typical examples of inorganic binders of the type under discussion are silicates, potassium silicate (K₂O—SiO₂), sodium silicate (Na₂O—SiO₂), silicon dioxide (H₂SiO₃) or SiO₂.

Water acts as a liquid carrier, i.e. solvent, which contains the other components of the coating liquid applied as per the invention, which evaporates easily while the finishing coat is drying and can be drawn off as steam and disposed of in an environmentally-friendly manner without greater effort. The water content of a coating liquid applied as per the invention is typically between 15 and 80% wt., more particularly generally more than 50% wt.

In addition to its main components ‘base metal compounds (oxide, nitride, sulphide, sulphate, carbide, hydrate or phosphate)’ and ‘binder’, the coating liquid applied to the flat steel product as per the invention, more particularly to the optional metal anti-corrosion coating, contains components, which improve, for example, its wetting properties or the distribution of the compound it contains as per the invention.

Practical tests have shown that optimum coating results are achieved if the coating liquid contains between 5 and 35% wt. of oxide, nitride, sulphate, sulphide, carbide, carbonate, fluoride, hydrate, hydroxide or phosphate compound components. Finishing coats are produced with such contents of the relevant compound components of the coating liquid, which consist of up to 94% wt. of a base metal compound (oxide, nitride, sulphide, sulphate, carbide, carbonate, fluoride, hydrate, hydroxide or phosphate).

With regard to minimising processing times and the coating result, a positive effect is achieved if the temperature of the coating liquid is between 20 and 90° C., more particularly between 40 and 70° C. upon application, wherein the finishing coat can be applied particularly effectively if the coating liquid is at a temperature of at least 60° C. It serves the same purpose if the temperature of the flat steel product is between 5 and 150° C., more particularly between 40 and 120° C., when the coating liquid is applied. Here, if the flat steel product is to be coated with an anti-corrosion coating applied to its base, the desired temperature of the flat steel product for the ‘application of the finishing coat’ step can be taken in the event of suitably close succession from the previous step ‘application of the protective metal coating’. An additional heating appliance is not required in this case.

Alternatively, it is also possible to apply the finishing coat as per the invention during a preparatory step prior to heat treatment, more particularly prior to hot press working. The heating required for heat treatment can be used here to dry the finishing coat. This proves advantageous particularly if the heat treatment involves heating for hot press working.

In the event that the flat steel product is provided for hot press working and is coated with an anti-corrosion coating, it may be advisable to transport the flat steel product after coating with the anti-corrosion coating firstly for further processing and to apply the finishing coat there shortly before the flat steel product enters the hot-forming furnace in which the flat steel product is heated to the temperature required for hot working.

The coating liquid can be applied by dipping, spraying or other conventional application methods.

Coating thickness can also be adjusted to the respective specified coating thickness of between 0.1 and 0.3 μm in a conventional manner by squeeze rolling, blowing off excess quantities of liquid, varying the solid content of the coating liquid or changing the temperature of the coating liquid.

The finishing coat applied as per the invention is typically dried at temperatures of between 100 and 300° C., wherein the typical drying time is between 5 and 180 seconds. Both the drying temperature and the drying times are measured here such that the drying process can be completed without difficulty in conventional drying appliances through which the respective flat steel product is guided in a continuous cycle.

A steel strip coated in a manner as per the invention can then be wound into coils and transported for further processing. The other process steps required to create a component from the flat steel product as per the invention can be carried out by the processor in a separate place and at another time.

Due to the reduced friction, which occurs, during working, upon contact of the flat steel products provided with a finishing coat in the manner as per the invention with the forming die, crack-free components can be produced from flat steel products coated as per the invention by hot press forming, where the forming of said components requires high degrees of stretching or complex forming. To produce a hot press formed component, a blank can be cut from a flat steel product provided with a finishing coat of the type as per the invention in a manner known per se, for example by laser cutting or with the help of another conventional cutting device, which is then heated to a deformation temperature above 700° C. and formed into the component in a forming die. In practice, typical deformation temperatures are between 700 and 950° C. with heating times of between 3 and 15 minutes.

The presence of the finishing coat as per the invention on the flat steel product to be formed allows rapid heating to the respective desired temperature that saves time and energy.

Optimum results are achieved for example, when processing a flat steel product, the base of which is made of steel containing between 0.3 and 3% wt. of Mn, if the temperature of the blank or component is no higher than 920° C., more particularly between 830 and 905° C. This applies particularly if the steel component is hot formed after being heated to the temperature of the blank or component such that the heated blank (‘direct’ method) or the heated steel component (‘indirect method’) is placed into the respective next forming die accepting that there will be a certain loss of temperature. The ultimate hot forming can then be carried out in a particularly reliable manner if the temperature of the blank or component respectively is between 850 and 880° C. on leaving the respectively used heating furnace. Depending on transport routes, transport times and environmental conditions, the temperature of the component in the die is in practice usually between 100 and 150° C. lower than the temperature on leaving the heating furnace.

Components obtained by forming at high temperatures of this kind can be cooled rapidly in a manner known per se proceeding from the respective deformation temperature in order to create a martensitic structure in the component and thus achieve optimum resilience.

The reduced friction in the forming die as a result of the finishing coat applied as per the invention makes a flat steel product as per the invention suitable, on account of the insensitivity of the flat steel product coated in a manner as per the invention to cracks in the steel substrate and abrasion, for single-stage hot press forming in particular, in which hot forming and the cooling of the steel component are carried out in the respective forming die using the heat from the previous heating process.

The properties of a flat steel product coated as per the invention naturally have an equally positive effect in multi-stage hot press hardening. In this variation of the method, firstly the blank is created and the steel component is then formed from this blank without intervening heat treatment. The steel component is then typically formed in a cold forming step in which one or a plurality of cold forming operations is performed. The degree of cold forming can be so great here that the steel component obtained is essentially formed completely finished. However, it is also conceivable to perform the initial forming as preforming and to complete the forming of the steel component in a forming die after heating. Said finished forming can be combined with the hardening step by performing the hardening as form hardening in a suitable forming die. Here the steel component is placed in a die reproducing its finished end form and cooled sufficiently rapidly in order to form the desired martensitic or tempered structure. Form hardening thus enables particularly good form retention of the steel component.

Regardless of which of the two versions of the method as per the invention is used, neither the forming nor the cooling required to form a martensitic or tempered structure have to be performed in a particular way that is different from the prior art. In actual fact, known methods and existing devices can be used for this purpose.

The components obtained as per the invention can be subsequently subjected to conventional joining and coating processes.

In connection with flat steel products, which are provided with an anti-corrosion coating, the invention is based on the following fundamental considerations:

The heating behaviour of anti-corrosion coatings, more particularly AS type coatings, is significantly poorer in the standard temperature range for hot forming of between 850 and 950° C. than that of non-coated, hot press form hardened sheet steel, which is typically a sheet steel made from a boracic Mn steel. For electromagnetic waves in the region of 1 μm, the absorption factor is a maximum of 0.3. Also in the wavelength range of approx. 2 to μm applicable to temperatures in the region of 900° C., the absorption behaviour of AS is still significantly below that of uncoated steel.

The maximum possible absorption behaviour at an absorption factor of 1 is described by the ‘black body’ model. However, substances, which are able to absorb a large amount of energy particularly in the infrared wavelength range of between 1 and 3 μm, do not necessarily have to be black.

It should be noted here that if the flat steel product includes an Al or Zn-based anti-corrosion coating and is not coated with a finishing coat in a manner as per the invention, the anti-corrosion coating reflects light and thermal radiation generally by more than 90%, i.e. has a degree of absorption of less than 10%. Since a degree of absorption of over 50% is achieved by applying a finishing coat as per the invention, significantly more heat is absorbed by the flat steel product thus also significantly reducing the time and energy required for heating.

There is also a positive influence on the minimisation of the time and energy required in this context in that some of the metal compounds provided as per the invention for the finishing coat change colour under the influence of heat and thus demonstrate even better absorption behaviour. It proves particularly beneficial here that compounds provided as per the invention for the finishing coat are particularly suited to rapid heating since their degree of absorption improves significantly at high energy densities and in the event of short-wave thermal radiation.

The absorption factor ε (<1) is determined by the chemical composition of the substance and in the form where the molecules convert as much radiation energy as possible into vibrations (phonons) in the desired wavelength range or where energy is absorbed through displacement of the outer electrons (more visible IR range >600° C.)

The transferable amount of heat is also determined by the surface morphology and thus by the roughness of the respective substrate. The following formula shows that increased roughness results in a larger surface and consequently better energy absorption:

Q=σεA(Ts⁴−T^{∞4})

Where Q: thermal flow through radiation
σ: Stefan-Boltzman constant=5.67*10⁻⁸ W/m² K
e: emission ratio, 0≦ε≦1
A: surface of the irradiated body
Ts: surface temperature in K
T^{∞}: ambient temperature in K

Taking account of the absorption factor, the energy absorbed therefore increases to the power of four in relation to the increase in temperature. If a thin coating is considered, which is much thinner than the wavelength of 2 to 3 μm, the absorbed energy still increases here to the power of three in relation to the increase in temperature. The flat steel product heats up due to stationary heat conduction from the finishing coat to the underlying substrate of the flat steel product, in particular, however due to the highly reduced reflection of thermal radiation. If the thickness of the finishing coat is less than the wavelength, the non-reflected part of the radiation directly heats the substrate underneath the finishing coat. Thus the effect of better heatability does not depend primarily on the thickness of the coating, but above all on the absorption characteristics of the finishing coat. Finishing coats with a thickness of just 0.1 μm offer measurable advantages here.

The degree of absorption of various substances depends on the band structure of the material, in which the photons of specific energy (IR spectrum) excite molecules which have quantum transitions with exactly this energy differential in their molecular vibrations. Most metallic salts are also characterised in addition to their high temperature stability by the fact that when applied as pigment with a small particle size, they have a high degree of absorption for light in the visible and near infrared (IR-A and IR-B) wavelength range.

Table 2 shows the measured absorption coefficients in the case of NIR radiation for some materials from which the finishing coat provided as per the invention can be formed.

Optimum absorption results can be achieved using a finishing coat which is procured and produced as follows:

a) Coating liquid applied to produce the finishing coat:
Solid content of inorganic components resistant to temperatures of up to 900° C.: 5 to 45% wt., more particularly 20 to 35% wt.,
Content of a binder resistant to temperatures of up to 900° C., more particularly a silicate-based binder: 1 to 15% wt., more particularly 7 to 12% wt.;
Solvent content (water): 50 to 94% wt., more particularly 30 to 75%;
Solid composition: 0.05 to 1 μm particle size, a particle size in the dry coating thickness range produces optimum coating roughness.
   b) Thickness of the finishing coat obtained
0.05 to 1 μm, more particularly 0.1 to 0.3 μm, as no specific absorption characteristics can be adjusted below 0.05 μm, however at coating thickness above 0.5 μm the direct transition of IR radiation into the protective metal coating is reduced.
   c) Drying of the finishing coat applied as a wet coat
Temperature range: 120 to 1000° C. The large temperature range is possible since no cross-linking and few temperature-related reactions of the coating take place. Drying that occurs as rapidly as possible increases roughness and thus the capacity to absorb IR waves. The coating can therefore also be applied immediately prior to the hot forming process.
   d) Roughness of the finishing coat obtained: Ra=1.0 to 2.0 μm

The invention is explained in greater detail below on the basis of test results:

### Test 1:

Steel blanks made of 28MnB5 steel coated using the hot dip method with a 20 μm thick, AlSi anti-corrosion coating, were sprayed with a coating liquid directly in terms of time and place after the production of the anti-corrosion coating to produce a finishing coat as per the invention. In addition to water, the coating liquid contained 25% wt. of a sulphide present as zinc sulphide producing the desired surface characteristics and 7% wt. of silicate as a binder to attach the finishing coat to the anti-corrosion coating. The thickness of the wet coat was set such that a finishing coat was obtained after drying which was completed during passage within 2 seconds by means of an NIR drier, where, at a surface weight of the finishing coat of 1 g/m², said finishing coat was 0.2 μm thick on each side.

The blanks coated in this manner reached the desired temperature of 890° C. within 190 seconds in the heating furnace through which they were conveyed during passage on ceramic rollers. The heating time was therefore 50 seconds shorter than the time taken to heat a blank coated only with the AlSi anti-corrosion coating and without the finishing coat as per the invention. It was also demonstrated that fewer deposits were left on the ceramic rollers in the heating furnace. A component was formed from the blanks heated in this manner and provided with a finishing coat as per the invention by hot press forming and subsequent hardening. Said component had a martensitic structure and could be welded and painted without the need for further cleaning or irradiation.

### Test 2

Steel blanks made of 22MnB5 steel coated using the hot dip method with a 25 μm thick, AlSi anti-corrosion coating, were coated with a coating directly in terms of time and place after the in-line production of the protective coating by means of a conventional coil coater to produce a finishing coat as per the invention. In addition to water, the coating liquid contained 5% wt. of a base metal fluoride in the form of hexafluorotitanic acid producing the desired characteristics of the finishing coat and 7% wt. of siloxane as a binder to attach the finishing coat to the protective metal coating.

The wet coat applied in this manner was then dried in an NIR drier and a convective holding line. The thickness of the wet coat was set here to produce a dry finishing coat with a thickness of 0.02 μm and a surface weight of 40 mg/m² per side. Drying took place during passage in a time of 5 seconds.

The blanks coated in this manner were heated in the heating furnace to a temperature of 900° C. within 180 seconds. This heating time was 50 seconds shorter than the time taken to heat a blank coated only with the AlSi anti-corrosion coating and without the finishing coat as per the invention. Fewer deposits were also apparent on the rollers of the ceramic furnace in which the blanks were heated. Moreover, it transpired that a component with a martensitic structure could be formed easily from the blanks coated with the finishing coat as per the invention by hot press forming and subsequent hardening. Said component could be welded and painted without the need for further cleaning or irradiation.

### Test 3

Steel blanks made of 22MnB5 steel coated using the hot dip method with a 15 μm thick, AlSi anti-corrosion coating, were coated with a coating liquid directly in terms of time and place after the in-line production of the protective coating by means of a reverse roll coating method to produce a finishing coat as per the invention. The coating liquid contained water and, as per the invention, 10% wt. of carbon black and graphite as well as the hydroxide compound producing the desired surface characteristics, 10% wt. of sodium hydroxide and 5% wt. of an alkaline silicate binder.

The finishing coat was applied as a wet coat with a surface density of 250 mg/m², which, at a density of 2.2 g/cm³, corresponds to a finishing coat thickness of approx. 0.1 μm in a wet state. The finishing coat applied in this manner was then dried in a convective drier at 250° C. as a result of which the thickness of the finishing coat was reduced to 0.01 μm in the fully dried state. Drying took place during passage in a time of 30 seconds. During the course of drying, the colour of the finishing coat changed to a darker shade which resulted in a further increase in the heat absorption capacity of the finishing coat.

The blanks coated with the finishing coat were heated in the heating furnace to 900° C. in 170 seconds thus requiring approx. 70 seconds less heating time than the blanks provided with an AlSi coating, which had not been coated with a finishing coat in a manner as per the invention. This test also confirmed that the finishing coat meant that significantly fewer deposits were left on the rollers on which the blanks were conveyed through the heating furnace. Deposits were also not observed in the die in the case of the blanks coated as per the invention, whereas in the case of conventional blanks not provided with the finishing coat, corresponding deposits and deposit build-up were apparent. The component obtained following hot press forming had a full martensitic structure and a coating alloyed in the expected manner. The finishing coat remaining on the surface does not lead to a deterioration of suitability for cathode dip painting. The component obtained also had excellent spot welding properties.

### Test 4

Steel blanks made of 22MnB5 steel coated using the hot dip method with a 20 μm thick, AlSi anti-corrosion coating, were spray coated with a coating liquid to produce a finishing coat as per the invention in continuous passage following the in-line production of the protective coating. The coating liquid contained water and 15% wt. of an earth metal carbon in the form of calcium carbonate (CaCO₃) and a further 8% wt. of silicic acid as a binder to attach the finishing coat to the protective metal coating.

The finishing coat applied as a wet coat was then dried in an NIR drier with adjacent convective holding line. During application, the thickness of the wet coat was set such that a finishing coat with a thickness of 0.18 μm and a surface density of 500 mg/m² per side was produced after drying. Drying took place during passage in a time of 10 seconds.

The blanks coated in this manner were heated in the heating furnace to 900° C. in 195 seconds. The time required for said heating was approx. 45 seconds shorter than the time required to heat blanks conventionally coated with an AlSi protective coating, however not with a finishing coat as per the invention.

In the course of heating the blanks as per the invention no deposits appeared on the rollers of the continuous furnace used for heating purposes. Fewer deposits were also observed in the die. The component obtained from the blanks coated as per the invention following hot press form hardening had a full martensitic structure and the expected alloying in the coating. The remains of the finishing coat on the surface did not lead to any deterioration of suitability for cathode dip painting and the required spot welding properties were also achieved.

### Test 5

Steel blanks made of 34MnB5 steel coated using the hot dip method with a 15 μm thick, AlSi anti-corrosion coating, were provided with a finishing coat by dipping in a coating liquid spray in line to produce a finishing coat on the protective coating directly in terms of time following the production of the protective coating. In addition to water, the coating liquid contains, in a manner as per the invention, 22% wt. of a base metal sulphide in the form of tin (II) sulphide (SnS) and a further 5% wt. of siloxane as a binder to attach the finishing coat to the protective metal coating.

The finishing coat applied in this manner as a wet coat with a surface density of 4 g/m² per side was dried in an NIR drier. Drying resulted in a dry coat with a surface density of 1.5 g/m² per side. Drying took place during passage in a time of 6 seconds.

The blanks provided with the finishing coat in this manner were heated in the heating furnace to a temperature of 890° C. in 190 seconds thus requiring approx. 50 seconds less than blanks coated in a conventional manner with an AlSi anti-corrosion coating, but not provided with a finishing coat as per the invention. No build-up of coating material was identified on parts of the furnace or the forming die, either during heating in the continuous furnace or during subsequent hot press form hardening. The hot press formed and hardened components obtained from the blanks coated as per the invention had a martensitic structure in their basic material in the same way as the components obtained in the other tests and could be welded and painted without the need for further cleaning or irradiation.

### Test 6

Steel blanks made of 22MnB5 steel coated using the hot dip method with a 25 μm thick, AlSi anti-corrosion coating, were spray coated in line with a coating liquid immediately after coating with the protective coating to produce a finishing coat. The coating fluid contained water and, as per the invention, 12% wt. of an alkaline metal carbon in the form of potassium carbonate (K₂CO₃). The coating liquid also contained a further 6% wt. of Na₂O—Si₂ as a binder for attaching the finishing coat to the protective metal coating.

The wet coat applied in this manner was then dried in a NIR drier with a convective holding line. The thickness of the wet coat was set in the process to produce a finishing coat with a surface density of 250 mg/m² on each side in the dried state, which at a density of 2.5 g/cm³ corresponds to a coating thickness of 0.1 to 0.15 μm on each side. Drying took place during passage in a time of 10 seconds.

The blanks coated in this manner were heated in a heating furnace to a temperature of 900° C. in 190 seconds thus requiring approx. 50 seconds less than blanks coated with AlSi without an additional coating as per the invention. No deposits were apparent on the ceramic furnace rollers of the heating furnace. Unlike in the processing of the blanks provided only with an AlSi coating and not equipped with a finishing coat as per the invention, only very few deposits were apparent in the die used for hot press form hardening.

Consequently, an exploitable speeding up of the heating phase in heating systems emitting IR radiation occurs in all finishing coats applied as per the invention at coating thicknesses of between 0.01 and 0.2 μm. This has the following advantages:

1. The finishing coat does not need to be removed at any point during processing.
2. Due to the short drying times, in-line application, i.e. continuously integrated into the heat treatment process, is possible.
3. The coating costs are low due to the small amount of coating liquid required.
4. The weldability of the components formed from the flat steel products coated as per the invention is not influenced by the finishing coat.
5. Standard cleaning processes are not contaminated by components of the finishing coat.
6. The ability to paint a flat steel product coated as per the invention or a component formed therefrom is comparable with the ability to paint products, which are formed from flat steel products that have no finishing coat as per the invention.
7. In the case of coatings containing iron or flat steel products provided with a non-metallic coating, the finishing coat as per the invention produces secondary corrosion protection. This applies particularly if the finishing coat is formed from oxidic compounds.
8. In the event that the flat steel product is coated with a metal anti-corrosion coating, the finishing coat applied as per the invention minimises the occurrence of abrasion and deposit build-up.

TABLE 1

| | | Effective | | |
|---|---|---|---|---|
| | | content of | | |
| | | other elements | | Reduction |
| | Coating | in the coating | | in heating |
| Symbol | base | (5% wt.) | Coating method | time (%) |
| AS | Al | Si: 8 to 12 | Hot dip coated | 20 to 30 |
| Z | Zn | Al: 0.1 to 0.2 | Hot dip coated | 25 to 35 |
| ZF | Zn | Fe: 8 to 15 | Hot dip coated, | 0 to 10 |
| | | | diffusion | |
| | | | annealed | |
| ZN | Zn | Ni: 8 to 12 | Galvanically | 10 to 20 |
| | | | coated | |
| ZA | Zn | Al: 5 | Hot dip coated | 25 to 35 |
| AZ | Al | Zn: 43.4 | Hot dip coated | 25 to 35 |
| | | Si: 1.6 | | |
| ZM | Zn | Mg: 0.5 to 5 | Hot dip coated | 10 to 20 |
| | | Al: 0.2 to 3 | | |

TABLE 2

| Absorption factor | Description | Formula |
|---|---|---|
| 0.2 to 0.3 | Aluminium oxide | Al₂O₃ |
| 0.2 to 0.3 | Titanium oxide | TiO₂ |
| 0.3 to 0.4 | Zinc oxide | ZnO |
| 0.4 to 0.5 | Magnesium oxide | MgO |
| 0.4 to 0.6 | Silicium oxide | SiO₂ |
| 0.5 to 0.7 | Soda (anhydrous) | Na₂CO₃ |
| 0.6 to 0.7 | Titanium fluoride | TiF₃ |
| 0.6 to 0.7 | Potash | K2CO3 |
| 0.7 to 0.8 | Chalk | CaCO3 |
| 0.7 to 0.8 | Gypsum | Ca[SO4]•2H2O |
| 0.85 | Titanium spinel | TiMg2O4 |

1. A hot-press formed component comprising a steel product comprising a separate finishing coat applied to at least one of the free surfaces of the flat steel product, the finishing coat containing at least one oxide-, nitride-, sulphide-, sulphate-, carbide-, carbonate-, fluoride-, hydrate-, hydroxide-, or phosphate-compound of a base metal.

2. The method according to claim 1, wherein the flat steel product further comprises a steel base layer and a metal protective coating for corrosion protection applied to the base layer and the finishing coat is applied to the protective coating.

3. The hot-press formed component according to claim 1, wherein the flat steel product further comprises a steel base layer and a metal protective coating for corrosion protection applied to the base layer and the finishing coat is applied to the protective coating.

4. The hot-press formed component according to claim 1, wherein the surface density of the finishing coat is between 0.01 and 15 g/m².

5. The hot-press formed component according to claim 1, wherein the finishing coat thickness is between 0.01 and 5 μm.

6. The hot-press formed component according to claim 1, wherein the base metal of the compound contained in the finishing coat belongs to the group of alkaline earth metals.

7. The hot-press formed component according to claim 1, wherein the base metal of the compound belongs to the group of alkaline metals.

8. The hot-press formed component according to claim 1, wherein the base metal of the compound belongs to the group of semi-metals.

9. The hot-press formed component according to claim 1, wherein the base metal belongs to the group of transition metals.

10. The hot-press formed component according to claim 1, wherein the base metal of the compound belongs to the group consisting of Na, K, Mg, Ca, B, Al, Si, Sn, Ti, Cr, Mn, and Zn.

11. The hot-press formed component according to claim 1, wherein the compound present in the finishing coat is particulate.

12. The hot-press formed component according to claim 11, wherein the average diameter of the particles in the compound is between 0.01 and 5 μm.

13. The hot-press formed component according to claim 1, wherein the finishing coat further comprises up to 15% wt. of carbon black or graphite.

14. A method for producing a hot-press formed component comprising:
heating a flat steel product comprising a separate finishing coat applied to at least one of the free surfaces of the flat steel product, the finishing coat containing at least one oxide-, nitride-, sulphide-, sulphate-, carbide-, carbonate-, fluoride-, hydrate-, hydroxide-, or phosphate-compound of a base metal to a deformation temperature; and
hot-press forming the flat steel product to form a hot-press formed component.

15. The method according to claim 14, wherein the finishing coat has an absorption coefficient for near infrared radiation of 0.2-0.8.

16. The method according to claim 14, wherein after hot-press forming, the hot-press formed component is rapidly cooled from the deformation temperature in order to produce a martensitic structure in the hot-press formed component.

17. The method according to claim 14, wherein the deformation temperature is greater than the austenization temperature of the flat steel product.

18. The method according to claim 14, wherein the deformation temperature is 700-950° C.

19. The method according to claim 14, wherein the flat steel product is heated for 3-15 minutes.

20. The method according to claim 14, wherein the finishing coat thickness is between 0.01 and 5 μm.
